(19) United States
(12) Patent Application Publication
(10) Pub. No.: US 2007/0028764 A1
(43) Pub. Date: Feb. 8, 2007

(54) Method for enabling the provision of purified carbon dioxide

(76) Inventors: Carsten Wittrup, Basking Ridge, NJ (US); Ravi Jain, Bridgewater, NJ (US); Charles Bronson Allen III, Downers Grove, IL (US)

Correspondence Address: THE BOC GROUP, INC., 575 MOUNTAIN AVENUE, MURRAY HILL, NJ, 07974-2064, US

(21) Appl. No.: 11/500,079

(22) Filed: Aug. 7, 2006

Related U.S. Application Data
(60) Provisional application No. 60/706,331, filed on Aug. 8, 2005.

(51) Int. Cl. B01D 53/30; B01D 53/02

(52) U.S. Cl. 95/8; 95/13; 95/136

(57) ABSTRACT

The invention provides a method for enabling the provision of purified carbon dioxide for direct use in operations requiring purified carbon dioxide, the method comprising passing impure carbon dioxide through various purification units for the removal of sulfur compounds, oxygenates, and aromatics. The present invention provides for a carbon dioxide supply systems, method and apparatus for purifying carbon dioxide and method for providing backup carbon dioxide. Sulfur species and other impurities are removed from the carbon dioxide by adsorption and reaction means.

### FIELD OF THE INVENTION

The present invention provides a method of providing gases. In particular, this invention is directed to a method for enabling the provision of purified carbon dioxide gases.

### BACKGROUND OF THE INVENTION

Carbon dioxide is used in a number of industrial and domestic applications, many of which require the carbon dioxide to be free from various impurities. Unfortunately carbon dioxide obtained from natural sources such as gas wells, chemical processes, fermentation processes or produced in industry, particularly carbon dioxide produced by the combustion of hydrocarbon products, often contains impurity levels of sulfur compounds such as carbonyl sulfide (COS) and hydrogen sulfide (H₂S) as well as oxygenates such as acetaldehydes and alcohols as well as aromatics such as benzene. When the carbon dioxide is intended for use in an application that requires the carbon dioxide to be of high purity, such as in the manufacture and cleaning of foodstuffs and beverage carbonation, medical products and electronic devices, the sulfur compounds and other hydrocarbon impurities contained in the gas stream must be removed to very low levels prior to use. The level of impurity removal required varies according to the application of carbon dioxide. For example, for beverage application the total sulfur level in carbon dioxide (CO₂) ideally should be below 0.1 ppm and aromatic hydrocarbons need to be below 0.02 ppm. For electronic cleaning applications removal of heavy hydrocarbons to below 0.1 ppm is required.

Various methods for removing sulfur compounds and hydrocarbon impurities from gases such as carbon dioxide are known. For example, U.S. Pat. No. 4,332,781, issued to Lieder et al., discloses the removal of COS and H₂S from a gas stream by first removing the H₂S from the hydrocarbon gas stream by contacting the gas stream with an aqueous solution of a regenerable oxidizing reactant, which may be a polyvalent metallic ion, such as iron, vanadium, copper, etc., to produce a COS-containing gas stream and an aqueous mixture containing sulfur and reduced reactant.

U.S. Pat. Nos. 5,858,068 and 6,099,619 describe the use of a silver exchanged faujasite and an MFI-type molecular sieve for the removal of sulfur, oxygen and other impurities from carbon dioxide intended for food-related use. U.S. Pat. No. 5,674,463 describes the use of hydrolysis and reaction with metal oxides such as ferric oxide for the removal of carbonyl sulfide and hydrogen sulfide impurities from carbon dioxide.

It is known to directly remove sulfur compounds, such H₂S from a gas stream by contacting the gas stream with metal oxides, such as copper oxide, zinc oxide or mixtures of these. It is also known to remove sulfur impurities such as COS by first hydrolyzing COS to H₂S over a hydrolysis catalyst and then removing H₂S by reaction with metal oxides.

Since many end users of carbon dioxide require the carbon dioxide they use to be substantially free of sulfur compounds, hydrocarbon and other impurities, and because natural sources of carbon dioxide and industrially manufactured carbon dioxide often contain sulfur and hydrocarbon compounds, economic and efficient methods for effecting substantially complete removal of sulfur and hydrocarbon compounds from carbon dioxide gas streams, without concomitantly introducing other impurities into the carbon dioxide, are continuously sought. Lower cost analysis methods for various impurities are also sought. Also, reliable methods for providing high purity carbon dioxide to manufacturing operations are sought. The present invention provides a simple and efficient method for achieving these objectives.

### SUMMARY OF THE INVENTION

In one embodiment, this invention provides a method for enabling the provision of purified gas, such as carbon dioxide, for direct use in operations requiring purified gas, such as carbon dioxide, the method comprising delivering carbon dioxide from a production facility to a location where purified carbon dioxide is to be used, passing carbon dioxide through various purification units for the removal of impurities, such as sulfur compounds, oxygenates, and aromatics, analyzing the purified carbon dioxide for impurities using at leat one analyzer, and passing a portion of the purified carbon dioxide that meets product purity specification to operations.

In an embodiment, the method herein provides the user direct use at a remote location. Further, at least a portion of the purified carbon dioxide may be used for backup storage.

The method herein comprises supplying carbon dioxide from a production plant, passing the carbon dioxide through various units for the removal of impurities such as sulfurs, and hydrocarbons including oxygenates, and aromatics, providing analytical means to ensure purity of carbon dioxide and supplying purified carbon dioxide to manufacturing operations. The method additionally consists of liquefying part of purified carbon dioxide and storing it as a backup.

The purity of the carbon dioxide is sufficient to meet the quality assurance needs. In an embodiment, the carbon dioxide is analyzed using detectors and impurities are concentrated prior to analysis. The operations in which the purified carbon dioxide is used is selected from the group consisting of manufacture and of foodstuffs and beverages, medical products and electronic cleaning devices customers.

### BRIEF DESCRIPTION OF THE DRAWINGS

While the specification concludes with claims distinctly pointing the subject matter that Applicants regard as their invention, the invention would be better understood when taken in connection with the accompanying drawing in which:

FIG. 1 is a schematic of carbon dioxide production and purification from a carbon dioxide purification facility.

### DETAILED DESCRIPTION OF THE INVENTION

The carbon dioxide that is typically produced for industrial operations has a number of impurities present in it. These impurities will often be a concern for many uses of the carbon dioxide, but in the production of products intended for human consumption such as carbonated beverages, and electronic manufacturing the purity of the carbon dioxide is paramount and can influence the taste, quality, and legal compliance of the finished product. In addition to the purity reliability of carbon dioxide supply is also a concern to the manufacturing operations which are usually continuous or semi-continuous. The present invention provides a method for reliably providing high purity carbon dioxide to manufacturing operations. Various point of use applications of carbon dioxide include a beverage filling plant, a food freezing plant, an electronics manufacturing plant and a fountain type carbon dioxide dispensing location.

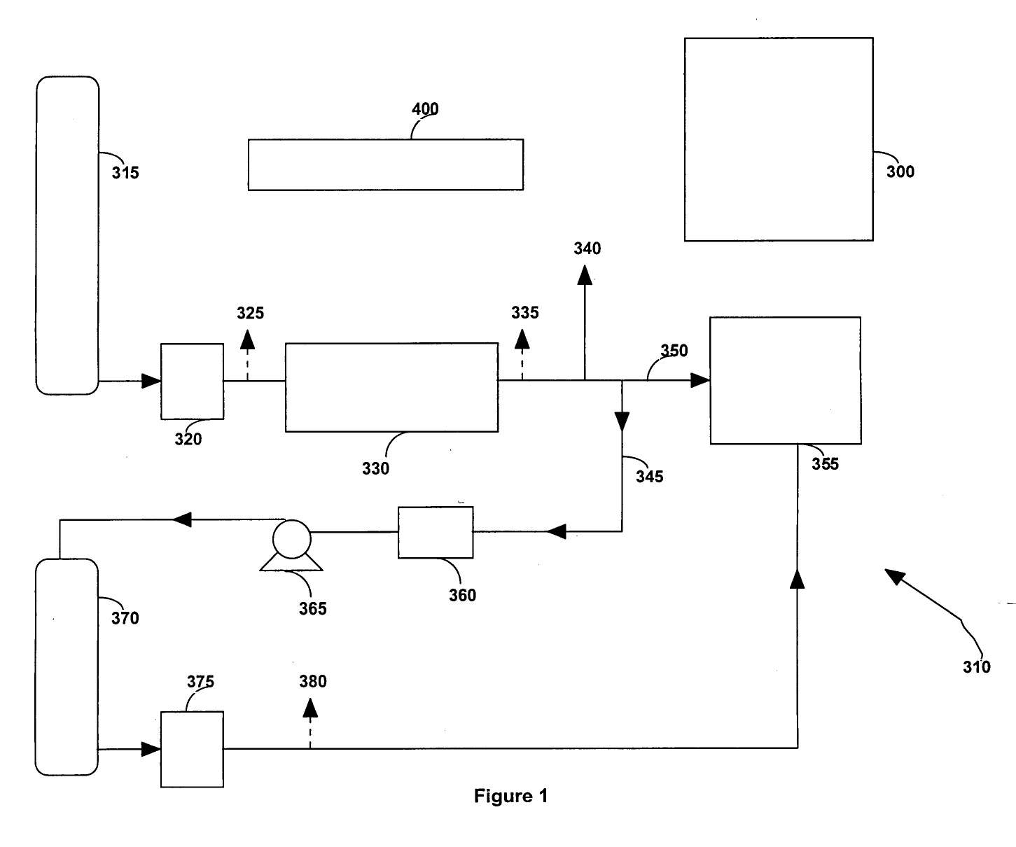

An embodiment of the invention is shown in FIG. 1. In FIG. 1, liquid carbon dioxide is obtained from a CO₂ production plant 300 located in the vicinity of facility 310 where CO₂ is used in manufacturing operations. Facility 310 can be a beverage filling plant or an electronics manufacturing plant. Carbon dioxide is delivered to storage tank 315, vaporized in vaporizer 320 and a stream 325 is sent to the analysis system 400. If the stream is within predetermined specifications with respect to the feed impurities it is sent to purification skid 330. A portion of stream exiting purification skid 330 is taken as stream 335 and analyzed by the analysis system 400. If it is within predetermined limits with respect to product impurities a majority of this purified stream is sent to manufacturing operation 355 as stream 350 and a smaller portion, 345, is sent for liquefaction and backup storage. If the stream exiting skid 330 is not within predetermined specifications it is vented as stream 340. The backup stream 345 is liquefied in chiller 360 and pumped to the storage tank 370 using a pump 365. When backup carbon dioxide is needed, for instance when stream exiting unit 330 is not within specifications, a CO₂ stream from storage tank 370 is vaporized in vaporizer 375 and a portion of this stream is taken as stream 380 for analysis in unit 400. If this stream is within specification for the impurities, it is sent to unit 355 for manufacturing operation.

The industries or customers where the present invention will have utility include but are not limited to the manufacturing and cleaning of foodstuffs; the manufacture of electronics, electronic components and subassemblies; the cleaning of medical products; carbonation of soft drinks, beer and water; blanketing of storage tanks and vessels that contain flammable liquids or powders; blanketing of materials that would degrade in air, such as vegetable oil, spices, and fragrances.

Potentially impure carbon dioxide in storage tank 315 can be obtained from any available source of carbon dioxide and may contain as impurities sulfur compounds such as carbonyl sulfide, hydrogen sulfide, dimethyl sulfide, sulfur dioxide and mercaptans, hydrocarbon impurities such as aldehydes, alcohols, aromatics, propane, ethylene, and other impurities such as water, carbon monoxide. These impurities are removed in the purification unit 330 and analyzed in the analyzer system 400. The purification unit contains several modules for the removal of sulfur impurities, hydrocarbons, oxygenates and aromatics.

For the purposes of this invention, at least some of the sulfur impurities such as hydrogen sulfide and carbonyl sulfide can be removed at an elevated temperature, a temperature of 500 to 150° C. These temperatures may be obtained by heater and heat-exchange means. Removal of sulfur impurities at these temperatures significantly improves the removal efficiency of these impurities. The sulfur purification materials include carbonates and hydroxides such as sodium and potassium hydroxides or carbonates on activated carbon; metal oxides such as copper, zinc, chromium or iron oxide either alone or supported on a microporous adsorbent such as activated alumina, activated carbon or silica gel. Other materials such as a CuY zeolite are effective for the removal of carbonyl sulfide and sulfur dioxide impurities through reaction. Activated carbon can also be used for the removal of mercaptans. Some of the materials, hydroxides and carbonates, may require oxygen to convert sulfur compounds such as hydrogen sulfide to sulfur and both oxygen and water to convert carbonyl sulfide to hydrogen sulfide and then to sulfur.

The hydrocarbon impurities are removed either by a combination of catalytic oxidation and adsorption or by adsorption alone. The catalyst bed will be after the sulfur removal bed. The stream temperature needs to be raised to between 150° and 450° C. for the oxidation of various hydrocarbon impurities by heater and heat exchange means. The reactor temperature depends on the impurity to be removed as well as the catalyst used. The materials used in the catalytic reactor are typically noble metals such as platinum or palladium on a particulate or monolith support. The reactor bed purifies the carbon dioxide by oxidation reactions and oxygen is added prior to the catalyst bed in appropriate amount. Typical impurities removed in the reactor include propane, aldehydes, alcohols, acetates, aromatics, methane, ethane and carbon monoxide.

The stream exiting the reactor beds or the sulfur removal beds is cooled to close to ambient temperatures in heat exchange means and sent to the adsorbent bed(s) for the removal of water and other impurities. The adsorption bed can remove any residual impurities and the reaction products from the catalyst bed as well as water or most of the impurities when the catalyst bed is not used. Typically, an adsorbent such as activated alumina (AA), a zeolite such as 4A or 3X or silica gel will be used for moisture removal. Other adsorbents such as such as a NaY zeolite or its composite forms (mixed with other adsorbents such as activated alumina) can be used for the removal of impurities such as aldehydes, alcohols such as methanol and ethanol, acetates such as methyl and ethyl acetates and some of the trace sulfur compounds such as dimethyl sulfur compounds. For these impurities, Y zeolites have significantly higher capacity than other zeolites and non-zeolitic materials. For aromatics such as benzene and toluene, adsorbents such as activated carbon or dealuminated Y zeolite can be used.

For the purposes of this invention, various impurities at various stages of the process are analyzed by a sulfur analyzer and a hydrocarbon analyzer. These two analyzers could be in a single unit such as a gas chromatograph or they could be separate units. Prior to analysis, various sulfur and hydrocarbon impurities can be concentrated to increase their amounts in the sample. This step improves the detection limits for various analyzers.

For use of carbon dioxide in beverage fill or electronic manufacturing, the carbon dioxide flow rates can range from 80 to 1,500 sm³/hr (standard cubic meter per hour) depending on the final application and the size of the production facility. The carbon dioxide will typically be at a pressure in the range of about 1.7 to about 21.5 bara with about 16 to about 20 bara being typical. In certain applications, particularly those related to the carbon dioxide for electronic cleaning, the pressures could range between 60 to several hundred bara.

The processes of the present invention are designed to address concerns with carbon dioxide impurities, particularly with carbon dioxide supplied at the point of use in the manufacturers' process. By purifying and analyzing at the same time, the operator of the production facility can rely on a steady supply of purified and quality assured carbon dioxide while the invention can also supply a back up storage tank with purified carbon dioxide to be used in any given situation where the real time supply of purified carbon dioxide is not sufficient or available to satisfy the demand. This allows the operator greater operating control over the purification process because the operator can stop or pause the process of purification if the impurity levels are not satisfactory for various impurities in the carbon dioxide.

### EXAMPLE 1

Testing was performed using a purification skid similar to that described in FIG. 1 to purify carbon dioxide. The purification skid contained modules for sulfur removal, a catalytic oxidation unit and an adsorber bed for the removal of water and remaining impurities. Carbon dioxide feed conditions were as follows:

| | |
|---|---|
| Pressure | 17 bara |
| Temperature | 25° C. |
| Flow Rate | 109.7 std m³/hr |
| H₂S | 5 to 9 ppm |
| COS | 5 ppm |
| Benzene | 2.5 ppm |
| Methanol | 160 ppm |
| Acetaldehyde | 11 ppm |
| Oxygen | About 50 ppm over the amount needed for H₂S, COS, |
| | benzene, acetaldehyde and methanol removal |

The sulfur reactor bed was operated at a temperature of 100° C. and contained 17.1 kgs of activated carbon impregnated with 20 wt % potassium carbonate. The catalytic reactor bed was operated at 250° C. and contained a palladium coated catalyst.

The unit was operated for over a week and the product was analyzed using a gas chromatograph containing an FID and FPD detectors and a sample concentrator. During the testing period the total sulfur in product exiting the sulfur removal bed 40 remained below 0.05 ppm and benzene, methanol and acetaldehyde were all below the detection limit of the instrument, less than 10 ppb each. An adsorption based sample concentrator allowed the increase in the concentration of hydrocarbon impurities by a factor of over 100 significantly increasing the detection limits for these impurities.

While the present invention has been described with reference to several embodiments and examples, numerous changes, additions and omissions, as will occur to those skilled in the art, may be made without departing from the spirit and scope of the present invention.

What is claimed is:

1. A method for enabling the provision of purified carbon dioxide for direct use in operations requiring purified carbon dioxide, the method comprising
a) delivering carbon dioxide from a production facility to a location where purified carbon dioxide is to be used;
b) passing carbon dioxide through various purification units for the removal of impurities to form purified carbon dioxide;
c) analyzing the purified carbon dioxide for impurities using at least one analyzer; and
d) passing a portion of the purified carbon dioxide that meets product purity specifications to operations.

2. The method as claimed in claim 1 wherein the direct use is at a remote location.

3. The method as claimed in claim 1 wherein a portion of the purified carbon dioxide is provided as backup storage.

4. The method of claim 1 further comprising analyzing the feed to ensure purity specifications.

5. The method as claimed in claim 1 wherein the impurities comprise sulfur compounds, and hydrocarbons including oxygenates and aromatics.

6. The method as claimed in claim 1 wherein the purity of the carbon dioxide is sufficient to meet quality assurance needs.

7. The method as claimed in claim 1 wherein each of the operations is selected from the group consisting of manufacture and cleaning of foodstuffs, medical products and electronic devices customers.

8. The method as claimed in claim 1 wherein the purification units comprise a sulfur reactor bed.

9. The method as claimed in claim 8 wherein the sulfur bed contains a catalyst that reacts with H₂S and COS.

10. The method as claimed in claim 8 wherein the catalyst is selected from the group consisting of carbonates and hydroxides, carbonates on activated carbon, carbonates on activated alumina, metal oxides, metal oxides supported on a microporous adsorbent, and CuY zeolite.

11. The method as claimed in claim 1 wherein the purification units further comprise a particulate or a monolith reactor bed.

12. The method as claimed in claim 11 wherein the reactor bed contains one or more catalyst materials.

13. The method as claimed in claim 11 wherein the purification units further comprise beds containing activated alumina and 13X zeolite.

14. The method as claimed in claim 13 wherein the activated alumina and 13X are layered on top of each other.

15. The method as claimed in claim 13 further comprising a NaY zeolite adsorbent.

16. The method as claimed in claim 9 further comprising activated carbon adsorbent.

17. The method as claimed in claim 1 wherein the carbon dioxide removal means comprises valve means for directing said carbon dioxide to either a production process or storage or both simultaneously.

18. The method of claim 1 comprising analyzing the carbon dioxide purity using detectors and concentrating the impurities prior to analysis.

19. The method as claimed in claim 1 further comprising sulfur analytical means and hydrocarbon analytical means.

20. The method as claimed in claim 1 which operates at a pressure of about 1.7 to 21.5 bara.

21. The method as claimed in claim 1 in which purification units operate at temperatures of about 40° C. to about 300° C.
